(19) United States
(12) Patent Application Publication
(10) Pub. No.: US 2008/0208595 A1
(43) Pub. Date: Aug. 28, 2008

(54) System and method for capturing steps of a procedure

(76) Inventor: Lloyd Elder, Edmonton (CA)

Correspondence Address: HEAD, JOHNSON & KACHIGIAN, 228 W 17TH PLACE, TULSA, OK, 74119, US

(21) Appl. No.: 11/881,046

(22) Filed: Jul. 25, 2007

(30) Foreign Application Priority Data
Feb. 28, 2007 (CA) 2,579,926

(51) Int. Cl. G10L 21/06

(52) U.S. Cl. 704/275

(57) ABSTRACT

The present invention relates to a system and method for capturing the steps of a procedure in a workplace or other environment to assist with operations, knowledge transfer or regulatory compliance and for other general purposes. The system and method enable a person to capture a procedure while actively carrying out the procedure in its associated environment.

### FIELD OF THE INVENTION

The present invention relates to a system and method for capturing the steps of a procedure in a workplace or other environment.

### BACKGROUND OF THE INVENTION

Procedures play an integral role in many organizations and companies and operations, knowledge transfer and regulatory compliance are often an ongoing concern. It takes a considerable amount of time and effort to develop safe, accurate and efficient standard operating procedures and traditional methods of procedural development are often somewhat ineffective.

In order to develop standard operating procedures, some businesses or organizations will hire external procedure writing consultants. However, such consultants are generally not familiar with the company or organization itself, nor are they typically familiar with the procedures which they are tasked to capture. Thus, accuracy and time are an issue. Moreover, hiring external consultants can be quite costly in some instances.

Some businesses will create a special position for or task a specific employee with writing procedures for the company. However, typical employees face many of the same challenges that externally hired consultants encounter. Although they may be familiar with the day to day operations of the company, they do not necessarily have an intimate knowledge of its procedures and can often get bogged down by process, complexity and the tedious aspects of writing.

A company or organization's experienced procedure operators and field personnel are without a doubt the most qualified and best suited individuals to write standard operating procedures. They possess an intimate knowledge of particular procedures as they carry the steps of the procedures out on a daily basis and are familiar with the conditions in which the procedures are carried out.

The difficulty with having experienced procedure operators or field personnel write procedures is that most companies do not have the time or resources to take these experts out of the workplace to create standard operating procedures. Experienced operators are extremely valuable and are usually not available or free to sit down and spend a large amount of time writing procedures. Moreover, the procedure experts are generally not writers, they are operators, and it is often a difficult and tedious task to get them to sit down and write a procedure.

Another difficulty with this approach is that operators and field personnel who are experts typically recall steps with less accuracy when they are not physically carrying out a particular procedure in the context of actual work within their work environment. It is also difficult for an operator to remember and account for all of the various hazards and conditions associated with carrying out a procedure when writing a procedure outside the context of actual work.

In some industries, safety hazards and noise levels in the work environment present a unique challenge in procedural operations. In plants or warehouses where machinery and other types of equipment are typically in use, the levels of background noise can be particularly high and safety is an issue.

### SUMMARY OF THE INVENTION

It is an object of the present invention to provide a system and method for capturing the steps of a procedure in an accurate, safe and efficient manner so as to result in less drain on company or organization time and resources.

It is a further object of the present invention to provide a system and method for capturing steps of a procedure wherein the steps of the procedure are captured while a person or experienced operator are actually physically carrying out the steps of the procedure within the context of the actual work environment.

It is a further object of the present invention to provide a system and method for capturing steps of a procedure wherein the system and method are suitable for capturing procedures in environments having a high level of background noise.

It is a further object of the present invention to provide a system and method for capturing steps of a procedure which permits a person or operator to capture the procedure in a hands free manner to ensure that the he or she can safely and efficiently physically perform the actual steps of the procedure while capturing the steps of the procedure.

According to one aspect of the present invention, there is provided a system for capturing steps of a procedure. The system comprises an earbone microphone for insertion into an ear of a person in order to transmit speech of the person and a recording device operatively connected to the earbone microphone for recording the speech of the person, the speech being the steps of the procedure dictated by the person. The system further includes a means for transferring the dictated procedure to a transcription site, a means for transcribing the dictated procedure at the transcription site, a means for validating the procedure after transcription and a means for storing the transcribed procedure.

According to another aspect of the present invention, there is provided a method of capturing steps of a procedure. The method comprises the steps of: inserting an earbone microphone into an ear of a person; operatively connecting a recording device to the earbone microphone; selectively activating the recording device to record speech transmitted via said earbone microphone; said person verbalizing the steps of the procedure such that the verbalization is transmitted from the earbone microphone to the recording device; recording the steps on the recording device; transferring the recorded steps to a transcription site; transcribing the recorded steps; and validating the transcribed steps to ensure the accuracy of the captured procedure.

### BRIEF DESCRIPTION OF THE DRAWINGS

These and other advantages of the invention will become apparent upon reading the following detailed description and upon referring to the drawings in which:

FIG. 1 is a perspective view of an earbone microphone inserted into the ear of a person and operatively connected to a recording device, in accordance with the present invention;

FIG. 2 is a perspective view of the earbone microphone shown in FIG. 1 operatively connected to the recording device; and

FIG. 3 is a flowchart of the preferred method of capturing procedures according to the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE INVENTION

In the following description, similar features in the drawings have been given similar reference numerals.

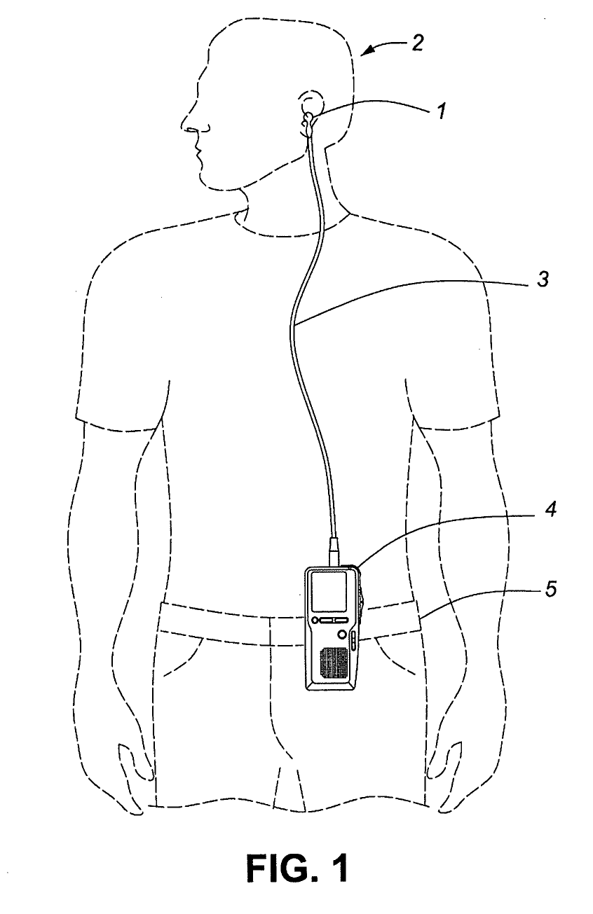

Turning now to FIG. 1, there is illustrated an earbone microphone (1) inserted into the ear of a person (2). The earbone microphone is preferably voice activated so as to be hands free in operation. This ensures that the microphone does not interfere with safety equipment. Other types of microphones such as the clip-on type or a headset, can often interfere with a hard hat or other equipment.

The voice activated earbone microphone is not activated by sound waves, but instead contains a bone conduction sensor for sensing vibrations in the auditory canal. The bone vibrations of voice sound information are converted into an electrical signal and transmitted via a transmitter to a recording device. The earbone microphone is therefore also equipped with a connector which is adapted to work with a recording device.

The earbone microphone (1) is also preferably adapted for one-way communication, so as not to include radio transmission, which is not intrinsically safe in industries such as oil and gas, where there cannot be any transmission. Although, in other industries two-way communication would also work. When the earbone microphone is adapted for one-way communication, the speaker is removed and the device contains only a microphone and the other necessary components for sensing and transmitting vibrations.

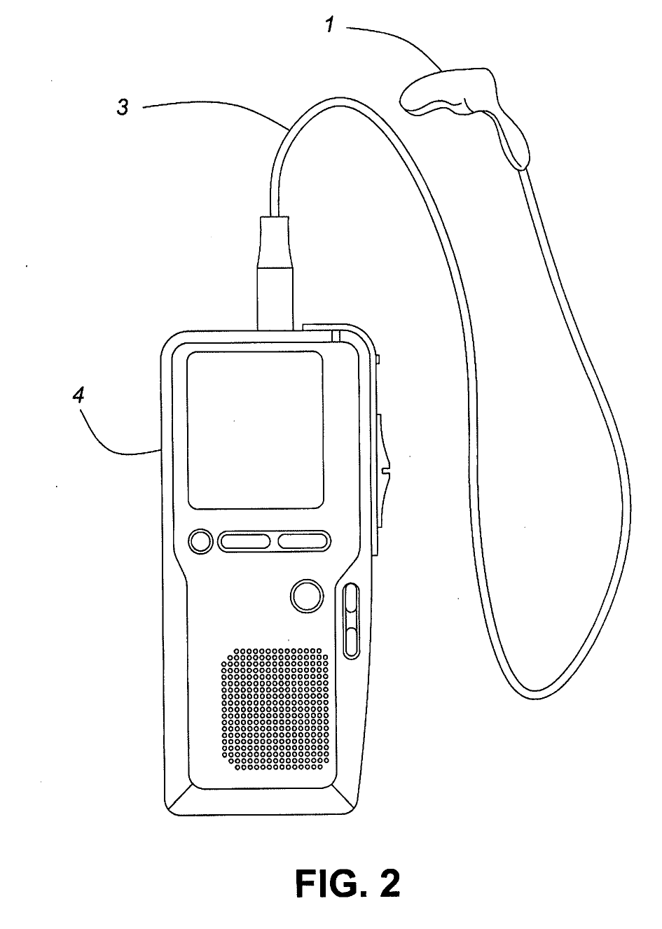

As shown in FIGS. 1 and 2 the earbone microphone (1) is operatively connected by a connector (3) to a recording device (4). The recording device (4) is of conventional design and may also preferably be voice activated so it does not require the use of a person's hands to operate. The recording device (4) may, for example, be attached to the belt (5) of a person (2), as shown in FIG. 1. Alternatively, the device may be placed in a pocket of the person's clothing. The recording device may be digital in nature, such as the DS4000 Olympus™ digital voice recorder.

In the system according the present invention, a person (2) while wearing the earbone microphone (1) and recording device (4), verbally dictates the steps of a procedure. This can readily be done while actively carrying out the steps of the procedure or while observing or supervising someone who is carrying out the steps of the procedure to be captured. The dictated speech is transmitted from the earbone microphone (1) to the recording device (4).

A means for transferring the dictated procedure to a transcription site is provided. The means may be wireless in nature or it may consist of a tape or memory card. Alternatively, the transfer may be made by way of email or other electronic transmission or USB transfer.

At the transcription site, a means for transcribing the dictated procedure is provided. A human being could act as the transcription means. For example, the recorded procedure could be provided to a human being to be transcribed via a conventional word processing program. The transcription site may be in the form of a call centre where trained subscribers listen to the voice recordings and enter the information from the voice recording into an approved template. Alternatively, the transcription means could consist of an automated transcription service.

During transcription, the procedure is typically placed into a standard template. For example, a template that is approved by the Occupational Safety and Health Administration (OSHA), or another regulatory body. After the procedure has been placed into an approved template, it is then indexed.

Once transcription has been completed, the accuracy of the transcribed procedure is validated. The means for validation can be determined by the company. For example, it can be operator validated, peer validated, supervisor validated, etc.

A storage means is provided for storing and maintaining the validated procedure for future reference. The validated procedure may be stored on site at the company or off site at a central facility. Alternatively, the procedure can be stored online for web access.

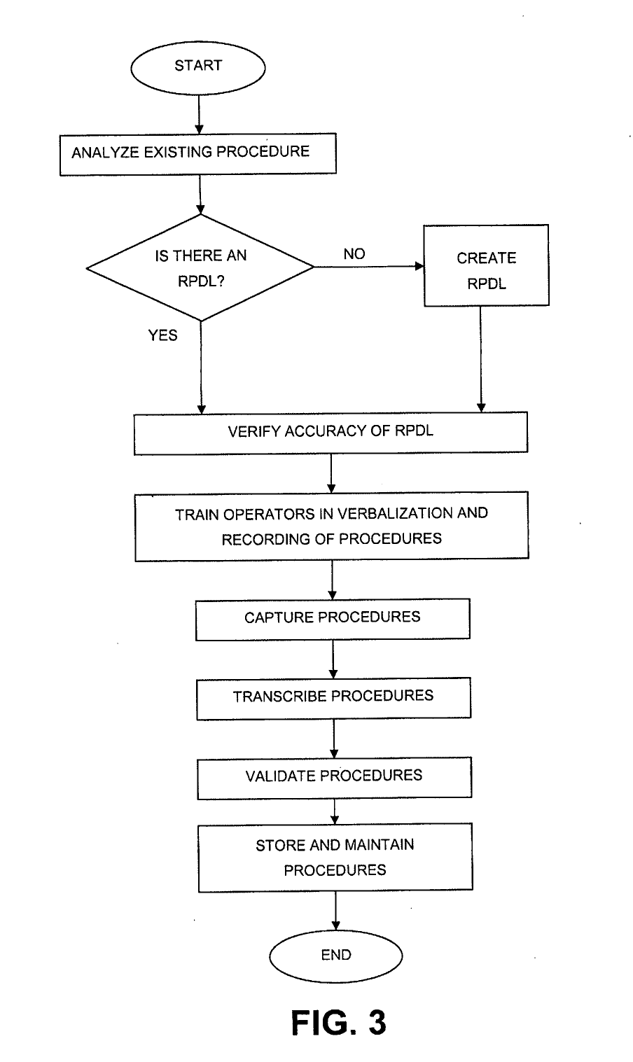

The steps of the method according to the present invention are illustrated in FIG. 3. As an optional first step, the existing procedures of a company or organization can be analyzed in order to determine whether there is already an existing required procedures development list (“RPDL”).

An RPDL is essentially a list of all of the standard operating procedures that a company or organization uses to operate. It typically details the name of each procedure, the best-practice experts for that procedure and the state the procedure is in (i.e. has it been developed, does it need validation, is it correct?). It has been shown that having an RPDL is very helpful in expediting the procedure capture process.

If there is no required procedures development list, then an RPDL can be created. Once there is an RPDL, then the accuracy of the RPDL is verified. At the verification stage, an assessment is typically made as to how each procedure in the RPDL would best be captured and by whom internally. At this stage, a standard template, which may be an OSHA standard template can be created and approved and stored for future use.

Once verification of the accuracy of the RPDL has been completed, a person is selected for capturing a procedure or procedures from the RPDL and training is optionally provided. The training covers verbalization skills and templates. If desired, the training may also include on-site coaching at the worksite.

Once training has been completed, at the worksite the selected person actively performs the steps of the assigned procedure and verbally dictates and records the steps using the earbone microphone (1) and the recording device (4) of the system described above. Alternatively, the person may be observing or supervising all or some of the steps of the procedure and dictating as the procedure is being carried out. During this step, a field coordinator from a company overseeing the method and system may be present to provide onsite management, ongoing training, file management and equipment calibration, if desired.

Once the steps of the procedure have been carried out and recorded, the recording is submitted either to the field coordinator, if one is present, or submitted directly to a transcription site. This can be done in any number of conventional means of transferring electronic data including by memory card, email, electronic transmission or connection to a computer. Alternatively, the recording may be copied to a recording media such as a tape, CD or DVD and then provided to the transcription site.

At the transcription site, the recorded procedures are transcribed and entered into the template (possibly an OSHA standard template, if appropriate) and then placed in an online search index for validation. Validation generally consists of reviewing the transcribed procedure and confirming the accuracy of the procedure. The validation may be performed by the person performing the procedure, a peer or a supervisor or another designated individual.

After validation has been completed, the validated procedure can be stored onsite at the company, offsite at a service provider or online and maintained for future reference. A company or organization can then easily keep track of the status of its standard operating procedures to determine which procedures are in place, which procedures are up to date and meet OSHA standards and which employees or members know how to perform which procedures to standard. A recurring validation plan may also be set up, so that the procedures are always kept up to date.

Thus, there has been provided in accordance with the invention a system and method for capturing steps of a procedure that fully satisfies the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. A system for capturing steps of a procedure, said system comprising:
an earbone microphone for insertion into an ear of a user in order to transmit speech of the user;
a recording device operatively connected to said earbone microphone for recording the speech of the user, whereby said speech is the steps of the procedure dictated by the user;
a means for transferring the dictated procedure to a transcription site;
a means for transcribing the dictated procedure at the transcription site;
a means for validating the procedure after transcription; and
a means for storing the transcribed procedure.

2. The system according to claim 1 wherein the recording device is voice activated and operates hands free.

3. The system according to claim 1 wherein the recording device is digital.

4. The system according to claim 1 wherein the earbone microphone is voice activated.

5. The system according to claim 1 wherein the earbone microphone and recording device are suitable for use in an environment having a high level of background noise.

6. The system according to claim 1 wherein the means for transferring the dictated procedure to the transcription site is wireless.

7. The system according to claim 1 wherein the user is a procedure expert.

8. The system according to claim 1 wherein the user is trained in proper verbalization and organization of the steps in the procedure.

9. The system according to claim 8 further including training aids to assist during verbalization.

10. The system according to claim 1 further including a template for organization of the steps of the procedure.

11. The system according to claim 10 wherein the template is OSHA approved.

12. The system according to claim 1 further including a means for sustaining the captured and validated procedures for future reference.

13. The system according to claim 1 wherein validation of the captured steps includes a review and verification of the procedure by said user or by another familiar with the procedure.

14. The method of capturing steps of a procedure, said method comprising the steps of:
inserting an earbone microphone into an ear of a user;
operatively connecting a recording device to the earbone microphone;
selectively activating said recording device to record speech transmitted via said earbone microphone;
said user verbalizing the steps of the procedure such that said verbalization is transmitted from said earbone microphone to said recording device;
recording said steps on said recording device;
transferring the recorded steps to a transcription site;
transcribing the recorded steps; and
validating the transcribed steps to ensure the accuracy of the captured procedure.

15. The method according to claim 14 further including a preliminary step of analyzing existing procedures to identify a required procedures development list before carrying out the remaining steps.

16. The method according to claim 15 further including a preliminary step of analyzing existing procedures to create a required procedures development list before carrying out the remaining steps.

17. The method according to claim 16 further including the step of validating the required procedures development list.

18. The method according to claim 15 further including the step of training an operator in verbalization and recording techniques prior to verbalizing the steps of the procedure.

19. The method according to claim 18 wherein the training further includes coaching and support during performance of the method of the user.

20. The method according to claim 15 further including the step of storing and maintaining the transcribed procedure.

21. The method according to claim 15 wherein said user is selected as an expert in the procedure to be captured.

22. The method according to claim 15 wherein transfer of the recorded steps of the transcription site is wireless.

23. The method according to claim 15 wherein the transcribed procedure is mapped to a template.

24. The method according to claim 23 wherein the template is OSHA approved.

25. The method according to claim 15 wherein said activation of said recording device is by voice activation.

26. The method according to claim 15 further including the step of providing on-site assistance to said user in the capture of said steps.

27. The method according to claim 15 wherein said step of verbalizing said steps includes said user dictating each of said steps while performing or observing the performance of said procedure.

28. The method according to claim 15 wherein said validation step includes a review of the transcribed steps by said user or by another familiar with the procedure to verify the accuracy of the captured step.
